(19) United States
(12) Patent Application Publication
(10) Pub. No.: US 2019/0011046 A1
(43) Pub. Date: Jan. 10, 2019

(54) HYDRAULIC CIRCUIT TO ENABLE UNIDIRECTIONAL FLOW UNDER FORWARD AND REVERSE POSITIVE DISPLACEMENT PUMP ROTATION

(71) Applicant: GM Global Technology Operations LLC, Detroit, MI (US)

(72) Inventors: Pete R. Garcia, North Branch, MI (US); Robert Parrish, White Lake, MI (US)

(21) Appl. No.: 15/641,411

(22) Filed: Jul. 5, 2017

(51) Int. Cl. F16H 61/4061; F16H 61/30; F04C 14/24; F04C 14/04

(52) U.S. Cl. CPC F16H 61/4061; F16H 61/30; F04C 2/34; F04C 14/04; F04C 14/24

(57) ABSTRACT

A hydraulic assembly includes a pump that is bi-rotationally driven by an output shaft of a transmission or transaxle and a hydraulic circuit that includes a pressure actuated control valve and a plurality of check valves. The check valves are arranged so that, regardless of the direction of rotation of the pump, the suction side of the pump is always in fluid communication with a sump and the pressure side of the pump is always in fluid communication with one of the inlet ports of the spool valve. In one direction of rotation of the pump, pressure in a line is supplied to a control port of a control valve to translate a control element to connect an outlet of the pump to the fluid system of the transmission or transaxle. In the other direction of rotation, no pressure is supplied to the control port and the control element, biased by a spring, connects the other outlet of the pump to the fluid system of the transmission.

### FIELD

The present disclosure relates to hydraulic circuits for providing pressurized oil or hydraulic fluid in transmission and transaxles and more particularly to a hydraulic circuit including a positive displacement, bi-rotational pump having unidirectional hydraulic fluid output flow for transmissions and transaxles.

### BACKGROUND

The statements in this section merely provide background information related to the present disclosure and may or may not constitute prior art.

Mechanically driven hydraulic pumps for transmissions and transaxles will invariably have mass, cost and packaging advantages over electrically driven pumps. A typical transmission uses a pump and valves to provide hydraulic fluid pressure and flow to the numerous mechanical devices of the transmission such as gears, bearings, actuators and electric motors. The location of the mechanically driven pump is not, however, without competing requirements and limitations. One option is to place it at the input to the transmission so that whenever the engine is rotating there is hydraulic fluid pressure and flow, but in many advanced propulsion transmissions, the engine is not always rotating and thus, under certain conditions, the pump will provide neither fluid pressure nor flow. As there is often a correlation between fluid consumption and vehicle speed, another option that is suggested and appears, superficially, to be advantageous, is a transmission output driven pump. Unfortunately, this choice ignores that fact that in reverse gear, the pump will rotate backwards, evacuating oil from the fluid network and returning it to the sump. Upon selection of a forward gear and attendant motion, several seconds may elapse before full hydraulic pressure is established.

From the foregoing, it is apparent that the location of the power input to a hydraulic pump is a transmission or transaxle is one of engineering constraints and compromises. The following disclosure addresses these constraints and compromises.

### SUMMARY

The present disclosure relates to a hydraulic fluid pump and hydraulic circuit for transmissions and transaxles having a bi-directionally rotating input that provides unidirectional output flow. The hydraulic pump is a positive displacement pump that is bi-rotationally driven by the output shaft of a transmission or transmission portion of a transaxle and a hydraulic circuit that includes a fluid pressure actuated and spring biased control valve and a plurality of check valves. The control valve operates and the check valves are arranged so that, regardless of the direction of rotation of the hydraulic pump, the inlet or suction side of the pump is always in fluid communication with the sump and the outlet or supply side of the pump is always in fluid communication with an outlet port of the control valve which supplies hydraulic fluid to the transmission. Specifically, in one direction of rotation of the pump, pressure in a line is supplied to the control port of the control valve to translate the spool or similar control element to connect the pressurized output of the pump to the fluid system of the transmission or transaxle. In the other direction of rotation of the pump, no fluid pressure is supplied to the control port of the control valve and the control element, biased by a spring, connects the other pressurized output of the pump to the fluid system of the transmission or transaxle.

Thus it is an aspect of the present disclosure to provide a hydraulic fluid pump for use in automatic transmissions and transaxles of a motor vehicle.

It is a further aspect of the present disclosure to provide a bi-directional hydraulic pump for use in automatic transmissions and transaxles of a motor vehicle that is driven by the output shaft of the transmission or the output shaft of the transmission portion of a transaxle.

It is a still further aspect of the present disclosure to provide a hydraulic pump assembly driven by the output shaft of an automatic transmission or transmission portion of a transaxle having a positive displacement pump and a hydraulic circuit that includes a fluid pressure actuated control valve and a plurality of check valves.

It is a still further aspect of the present disclosure to provide a hydraulic pump assembly driven by the output shaft of an automatic transmission or the transmission portion of a transaxle having a positive displacement pump and a hydraulic circuit that includes a fluid pressure actuated and spring biased control valve and a plurality of check valves.

It is a still further aspect of the present disclosure to provide a hydraulic pump assembly driven by the output shaft of an automatic transmission or the transmission portion of a transaxle having a bi-directionally rotated positive displacement pump and a hydraulic circuit that includes a fluid pressure actuated and spring biased control valve and a plurality of check valves.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is a schematic view with a portion broken away of an exemplary engine, automatic transmission and hydraulic pump assembly according to the present disclosure;

FIG. 1B is a schematic view with a portion broken away of an exemplary engine, transaxle including an automatic transmission and differential and hydraulic pump assembly according to the present disclosure;

FIG. 2 is a hydraulic circuit flow diagram of a hydraulic pump and circuit according to the present disclosure in a static (quiescent) state;

FIG. 3 is a flow diagram of a hydraulic pump and circuit according to the present disclosure with the transmission output shaft rotating in reverse and the associated vehicle travelling backward; and

FIG. 4 is a flow diagram of a hydraulic pump and circuit according to the present disclosure with the transmission output shaft rotating in a forward direction and the associated vehicle travelling forward.

### DETAILED DESCRIPTION

The following description is merely exemplary in nature and is not intended to limit the present disclosure, application, or uses.

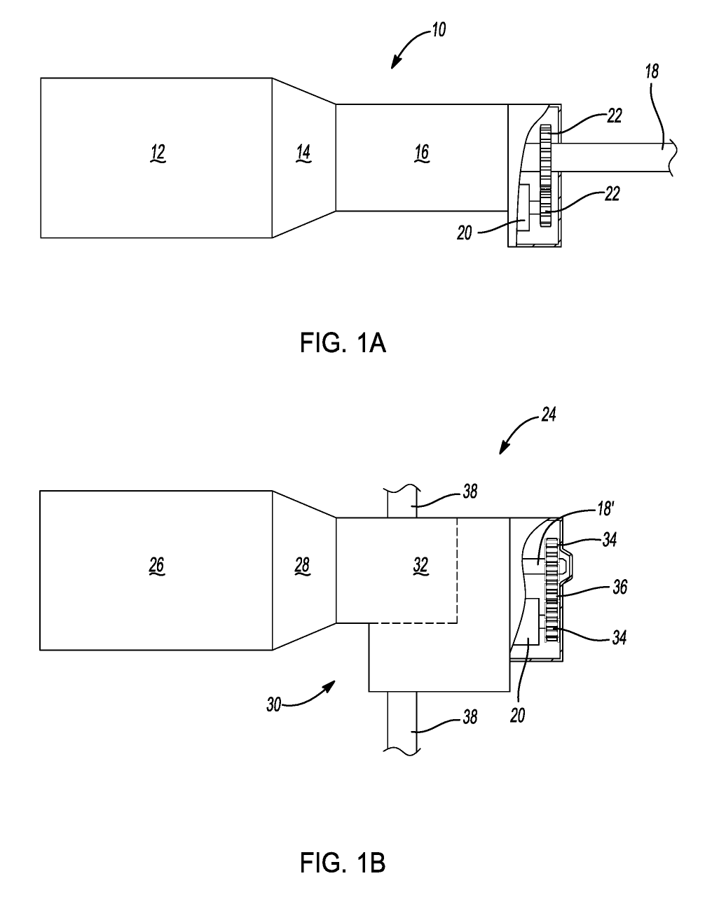

With reference now to FIG. 1A, a portion of a typical and exemplary motor vehicle powertrain is illustrated and designated by the reference number 10. The powertrain portion 10 includes a prime mover 12 such as a gas or Diesel fueled internal combustion engine or hybrid power plant, a torque converter 14 driven by the output of the prime mover 12, an automatic transmission 16 driven by the output of the torque converter 14. The automatic transmission 16 may be either a planetary gear, dual clutch type or a continuously variable (CVT) type. The automatic transmission 16 provides drive torque to an output shaft 18 that drives a bi-directional, fixed displacement hydraulic pump 20 through a pair of meshing gears 22. The vehicle powertrain 10 will typically also include a propshaft coupled to and driven by the transmission output shaft 18, a differential, a pair of axles and tires and wheels (all not illustrated). The hydraulic pump 20 and its associated hydraulic circuit will be further described below.

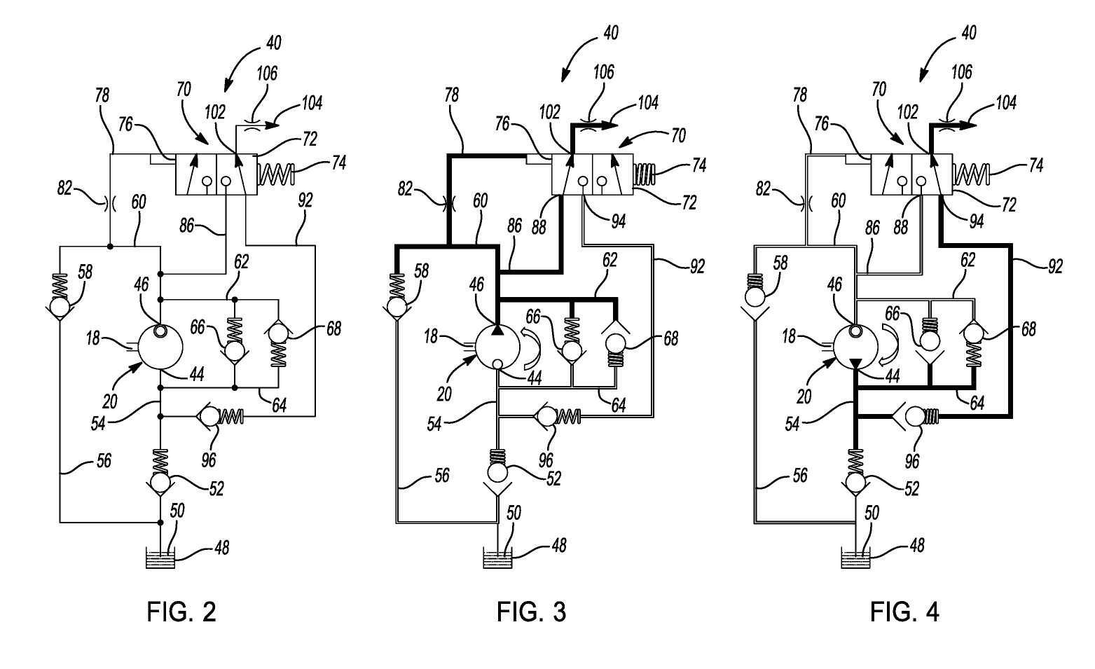

With reference now to FIG. 1B, a portion of another typical and exemplary motor vehicle powertrain including a transaxle is illustrated and designated by the reference number 24. The powertrain portion 24 also includes a prime mover 26 such as a gas or Diesel fueled internal combustion engine or hybrid power plant, a torque converter 28 driven by the output of the prime mover 26, a transaxle 30, that is, a combined transmission and differential, driven by the output of the torque converter 28. The automatic transmission portion 32 of the transaxle 30 may either be a planetary gear, dual clutch type or CVT. The output shaft 18′ of the transmission portion 32 of the transaxle 30 provides drive torque to the hydraulic pump assembly 20 through a pair of chain sprockets 34 and a multi-link chain 36. The vehicle powertrain 24 also includes a pair of axles 38, and tires and wheels (not illustrated). The hydraulic pump 20 and its associated hydraulic circuit, as noted above, will be further described below in connection with FIGS. 2, 3 and 4.

It should be understood that the drive configuration for the pump 20 of FIG. 1A, that is, an output shaft 18 driving the hydraulic pump 20 through a pair of meshing gears 22 is equally suitable and appropriate for use with the transaxle 30 of FIG. 1B and that the drive configuration for the pump 20 of FIG. 1B, that is, an output shaft 18′ driving the hydraulic pump 20 through a pair of sprockets 34 and a multi-link chain 36 is equally suitable and appropriate for use with the automatic transmission 16 of FIG. 1A.

At the outset, it will be appreciated and understood by those skilled in the art of power transmission that the meshing gears 22 illustrated in FIG. 1A and the sprockets 34 and chain 36 of FIG. 1B will drive the hydraulic pump 20 in opposite directions relative to the direction of rotation of the transmission output shaft 18 and 18′. That is, the sprockets 34 and the chain 36 will drive the hydraulic pump 20 in the same direction as the output shaft 18′ of the transmission portion 32 whereas the meshing gears 22 will drive the hydraulic pump 20 in the opposite direction as the transmission output shaft 18. While fine tuning of the flow and pressure characteristics of the hydraulic pump 20 may be preferable or desirable in certain applications, this flexibility, i.e., driving the hydraulic pump 20 in either direction while producing fluid pressure and flow, is one of the basic advantages of the present disclosure: regardless of the direction of rotation of the hydraulic pump 20, a flow of pressurized hydraulic fluid is always provided.

Referring now to FIG. 2, a flow diagram including the hydraulic pump 20 and its associated hydraulic circuit is illustrated and generally designated by the reference number 40. In FIG. 2, the hydraulic circuit 40 and the hydraulic pump 20 are shown in a static or quiescent state. The hydraulic circuit 40 includes the bi-directional, preferably fixed displacement, hydraulic pump 20 such as a vane, gear or gerotor pump which is driven by the output shaft 18 of the transmission 16 or the transmission portion 32 of the transaxle 30. In this regard, and as noted above, the speed and direction of rotation of the pump 20 is that of the output shaft 18 of the transmission 16 or the transmission portion 32 of the transaxle 30, respectively, and is thus directly related to the speed and direction of the associated motor vehicle (not illustrated).

The hydraulic pump 20 includes a first port 44 and a second port 46 which function, in one direction of rotation of the pump 40, as the suction (inlet) side and the supply (outlet) side and, in the opposite direction of rotation, as the supply (outlet) side and the suction (inlet) side. A transmission sump 48 disposed in the bottom of the transmission 16 or the transmission portion 32 of the transaxle 30 receives, stores and provides hydraulic fluid 50 through a first check valve 52 and a first fluid supply line 54 to the first port 44. The first check valve 52 is configured to open when the fluid pressure is lower at the first port 44 of the pump 20 than at the sump 48, that is, when, due to the direction of rotation of the hydraulic pump 20, the first port 44 is acting as the suction (inlet) side. A second fluid supply line 56 communicates between one side of a second check valve 58 and the sump 48 and a third fluid supply line 60 provides fluid communication between the other side of the second check valve 58, the second port 46 of the pump 20 and other components. The second check valve 58 is configured to open when the fluid pressure is lower at the second port 46 of the pump 20 than at the sump 48, that is, when due to the direction of rotation of the hydraulic pump 20, due to the direction of rotation of the hydraulic pump 20, the second port 46 is acting as the suction (inlet) side.

Disposed in parallel opposition across the first port 44 and the second port 46 of the pump 20 between a hydraulic line 62 (which is an extension of the third fluid supply line 60) and a hydraulic line 64 (which is an extension of the first fluid supply line 54) are a third bypass or pressure relief check valve 66 and a fourth bypass or pressure relief check valve 68. The third bypass or pressure relief check valve 66 opens when pressure at the first port 44 of the pump 20 is significantly higher than the pressure at the second port 46 to control or limit the maximum delivered hydraulic fluid pressure and is closed during conditions of nominal fluid consumption and pressure as well as rotation of the pump 20 in the opposite direction. The fourth bypass or pressure relief check valve 68 opens when pressure at the second port 46 of the pump 20 is significantly higher than the pressure at the first port 44 to control or limit the maximum delivered hydraulic fluid pressure and is closed during conditions of nominal fluid consumption and pressure as well as rotation of the pump 20 in the opposite direction.

The hydraulic circuit 40 also includes a two position, hydraulically actuated control valve 70, such as a spool valve or similar device having an axially translating spool 72 or similar moving member that is biased by a compression spring 74 toward a control port 76. The control port 76 is provided with hydraulic fluid through a fourth fluid line 78 (which is an extension of the third fluid supply line 60) having a metering orifice or flow restriction 82. The metering orifice 82 restricts hydraulic fluid flow to the control port 76 and slows translation of the spool 72, slowing transition between the two positions (states) of the control valve 70, thereby reducing transients and smoothing operation of the pump 20, its fluid output and the associated powertrain components.

The hydraulically actuated control valve 70 is provided with pressurized hydraulic fluid through two lines: a first valve supply line 86 (which is an extension of the third fluid supply line 60) which communicates with a first inlet port 88 of the control valve 70 and a second valve supply line 92 which communicates with a second inlet port 94 of the control valve 70 and the first fluid supply line 54 though a fifth check valve 96. An outlet or supply port 102 of the control valve 70 provides pressurized hydraulic fluid flow output of the control valve 70 to a supply line 104 which includes a second metering orifice or flow restriction 106 and which provides such hydraulic fluid to the components of the transmission 16 or transmission portion 32 of the transaxle 30 such as gears, bearings, hydraulic actuators, clutches and electric motors. Once again, the orifice 106 restricts fluid flow to smooth fluid delivery as the valve spool 72 transitions between its two states.

Referring now to FIG. 3, operation of the hydraulic circuit 40 and the hydraulic pump 20 in the reverse direction of vehicle travel will first be described. In FIG. 3 the darker (bolder) fluid lines represent those under pressure. At the outset, note that the first check valve 52 is open as the hydraulic pump 20 draws fluid from the sump 48 and pressurizes the third fluid supply line 60. Thus, the control port 76 of the hydraulically actuated control valve 70 is pressurized and the spool 72 is translated to the right in FIG. 3, against the biasing force of the spring 74.

Accordingly, the first valve supply line 86 (which is an extension of the third fluid supply line 60) which communicates with the first inlet port 88 of the control valve 70 is connected to the outlet port or supply port 102 of the control valve 70 and the supply line 104, thereby providing hydraulic fluid to the components of the transmission 16 or the transmission portion 32 of the transaxle 30. For purposes of complete illustration and explanation, the fourth bypass or pressure relief check valve 68 is shown in FIG. 3 in its open position which provides pressure relief and recirculation or bypass of the pump 20. This will occur, as noted above, only when significant or excessive pressure has built up in the fluid lines 60 and 62.

Referring now to FIG. 4, operation of the hydraulic circuit 40 and the hydraulic pump 20 in the forward direction of vehicle travel, and opposite direction of rotation of the hydraulic pump 20 from that illustrated in FIG. 3, will next be described. In FIG. 4 the darker (bolder) fluid lines represent those under pressure. At the outset, note that the first check valve 52 is closed as the hydraulic pump 20 draws fluid from the sump 48 through the second fluid supply line 56, the second check valve 58 and the third fluid supply line 60. Under this condition, the control port 76 of the hydraulically actuated control valve 70 is at a partial vacuum due to the suction of the hydraulic pump 20 and, also as a result of the biasing force of the spring 74, the spool 72 translates to the left in FIG. 4.

Accordingly, the first inlet port 88 of the control valve 70 is closed and the second inlet port 94, which is supplied with pressurized hydraulic fluid in the line 92 from the port 44 of the hydraulic pump 20 through the fifth check valve 96, connects to the outlet port or supply port 102 of the control valve 70 and the supply line 104, thereby providing hydraulic fluid to the components of the transmission 16 or transmission portion 32 of the transaxle 30. For purposes of complete illustration and explanation, the third bypass or pressure relief check valve 66 is shown in FIG. 4 in its open position which provides pressure relief and recirculation or bypass of the pump 20. This will occur, as noted above, only when significant or excessive pressure has built up in the fluid lines 54 and 64.

It should be noted that in the foregoing description, for reasons of clarity and full explanation, certain hydraulic lines, such as the fourth hydraulic line 78 and the first valve supply line 86 are specifically referenced and described although they are, in fact, in direct communication with, an extension of and thus an integral part of another fluid line, in this case, the third fluid supply line 60. Accordingly, interpretation of the following claims should take into consideration that recited fluid lines may be portions or sections of other connected or associated lines, rather than separate, independent fluid lines.

The description of the invention is merely exemplary in nature and variations that do not depart from the gist of the invention are intended to be within the scope of the invention. Such variations are not to be regarded as a departure from the spirit and scope of the invention.

What is claimed is:

1. A hydraulic fluid supply circuit for a motor vehicle powertrain component comprising, in combination,
a hydraulic fluid sump,
a bi-directional hydraulic pump having inlet and outlet ports,
a first fluid line communicating between the sump and one of the ports and having a check valve configured to allow fluid flow from the sump to the one of the ports,
a second fluid line communicating between the sump and another of the ports and having a check valve configured to allow fluid flow from the sump to the another of the ports,
a control valve having a control element biased by a spring, a control port at an end of the control element, a first and a second inlet port and an outlet port,
a first valve supply line communicating between the another of the ports and the first inlet port of the control valve,
a fourth fluid line communicating between the another of the ports and the control port of the control valve, and
a second valve supply line communicating between the one of the ports and the second inlet port of the control valve and having a check valve configured to allow fluid flow between the one of the ports and the second inlet port,
whereby the outlet port of the control valve is supplied with pressurized hydraulic fluid in either direction of rotation of the bi-directional hydraulic pump.

2. The hydraulic fluid supply circuit of claim 1 further including a first pressure relief check valve disposed between the inlet and outlet ports of the hydraulic pump configured to allow flow in a first direction and a second pressure relief check valve disposed between the inlet and outlet ports of the hydraulic pump configured to allow flow in a second direction.

3. The hydraulic fluid supply circuit of claim 1 wherein the bi-directional hydraulic pump is driven by an output shaft of a transmission.

4. The hydraulic fluid supply circuit of claim 1 wherein the bi-directional hydraulic pump is driven in a first rotational direction when an associated vehicle is moving forward and in an opposite rotational direction when the associated vehicle in moving backward.

5. The hydraulic fluid supply circuit of claim 1 further including a first flow restriction in the fourth fluid supply line and a second flow restriction in a line communicating between the first outlet port of the control valve and components of a transmission.

6. The hydraulic fluid supply circuit of claim 1 wherein the control element of the control valve closes off one of the inlet ports and connects another of the inlet ports to the outlet port.

7. A hydraulic fluid supply assembly for a motor vehicle automatic transmission comprising, in combination,
a hydraulic fluid sump,
a bi-directional fixed displacement hydraulic pump having suction and supply ports,
a first fluid line communicating between the hydraulic fluid sump and one of the ports and having a first check valve configured to allow fluid flow from the hydraulic fluid sump to the one of the ports,
a second fluid line communicating between the hydraulic fluid sump and another of the ports and having a check valve configured to allow fluid flow from the hydraulic fluid sump to the another of the ports,
a control valve having a control element having a pair of ends, a control port at one of the ends of the control element and compression spring at another of the ends of the control element, a first inlet port, a second inlet port and an outlet port,
a first valve supply line communicating between the another of the ports of the hydraulic pump and the first inlet port of the control valve,
a fluid line communicating between the first valve supply line and the control port of the control valve, and
a second valve supply line communicating between the one of the ports and the second inlet port of the control valve and having a check valve configured to allow fluid flow between the one of the ports and the second inlet port,
whereby the outlet port of the control valve is supplied with pressurized hydraulic fluid in either direction of rotation of the bi-directional hydraulic pump.

8. The hydraulic fluid supply assembly for an automatic transmission of claim 7 further including a first pressure relief check valve disposed between the inlet port and the outlet port of the hydraulic pump configured to allow flow in a first direction and a second pressure relief check valve disposed between the inlet port and the outlet port of the hydraulic pump configured to allow flow in a second direction.

9. The hydraulic fluid supply assembly for an automatic transmission of claim 7 wherein the bi-directional hydraulic pump is driven by an output shaft of a transmission.

10. The hydraulic fluid supply assembly for an automatic transmission of claim 7 wherein the bi-directional hydraulic pump is driven in a first rotational direction when an associated vehicle is moving forward and in an opposite rotational direction when the associated vehicle in moving backward.

11. The hydraulic fluid supply assembly for an automatic transmission of claim 7 further including a first flow restriction in the fluid line communicating between the first valve supply line and the control port of the control valve and a second flow restriction in a line communicating between the first outlet port of the control valve and components of a transmission.

12. The hydraulic fluid supply assembly for an automatic transmission of claim 7 wherein translation of the control element of the control valve closes off one of the inlet ports and connects another of the inlet ports to the outlet port.

13. A hydraulic fluid supply circuit for a motor vehicle automatic transmission comprising, in combination,
a hydraulic fluid sump,
a bi-directional hydraulic pump having a suction port and a supply port,
a first fluid line communicating between the hydraulic fluid sump and one of the ports of the hydraulic pump and having a first check valve configured to allow fluid flow from the hydraulic fluid sump to the one of the ports,
a second fluid line communicating between the hydraulic fluid sump and another of the ports of the hydraulic pump and having a check valve configured to allow fluid flow from the hydraulic fluid sump to the another of the ports,
a control valve having a control element having a pair of ends, a control port at one of the ends of the control element and a spring at another of the ends of the control element, a first inlet port, a second inlet port and an outlet port,
a first valve supply line communicating between the another of the ports of the hydraulic pump and the first inlet port of the control valve,
a fluid line communicating between the first valve supply line and the control port of the control valve,
a second valve supply line communicating between the one of the ports and the second inlet port of the control valve and having a check valve configured to allow fluid flow between the one of the ports and the second inlet port, and
a flow restriction in the fluid line communicating between the first valve supply line and the control port of the control valve.

14. The hydraulic fluid supply circuit for an automatic transmission of claim 13 further including a first pressure relief check valve disposed between the inlet port and the outlet port of the hydraulic pump configured to allow flow in a first direction and a second pressure relief check valve disposed between the inlet port and the outlet port of the hydraulic pump configured to allow flow in a second direction.

15. The hydraulic fluid supply circuit for an automatic transmission of claim 13 wherein the bi-directional hydraulic pump is driven by an output shaft of a transmission.

16. The hydraulic fluid supply circuit for an automatic transmission of claim 13 wherein the bi-directional hydraulic pump is driven in a first rotational direction when an associated vehicle is moving forward and in an opposite rotational direction when the associated vehicle in moving backward.

17. The hydraulic fluid supply circuit for an automatic transmission of claim 13 further including a second flow restriction in a line communicating between the first outlet port of the control valve and components of a transmission.
